(19) United States
(12) Patent Application Publication
(10) Pub. No.: US 2012/0203759 A1
(43) Pub. Date: Aug. 9, 2012

(54) METHOD, SYSTEM AND COMPUTER-READABLE RECORDING MEDIUM FOR WRITING NEW IMAGE AND ITS INFORMATION ONTO IMAGE DATABASE

(75) Inventors: Tae Hoon Kim, Gyeonggi-do (KR); Min Je Park, Gyeonggi-do (KR); Song Ki Choi, Seoul (KR)

(73) Assignee: OLAWORKS, INC., Seoul (KR)

(21) Appl. No.: 13/298,462

(22) Filed: Nov. 17, 2011

(30) Foreign Application Priority Data
Feb. 7, 2011 (KR) 10-2011-0010624

(51) Int. Cl. G06F 17/30

(52) U.S. Cl. 707/710; 707/E17.108; 707/E17.02

(57) ABSTRACT

The present invention relates to a method for writing a newly recognized image. The method includes the steps of: (a) comparing pre-stored image in the image database with a queried image; (b) storing the queried image onto a database for unrecognized images if there is no image similar to the queried image; (c) grouping the images in the database for unrecognized images based on degrees of similarity thereamong; and (d) comparing, if a specific image and its tag information are inputted, the specific image with some images included in a specific set of images among the organized sets of the images, determining whether there is any image in the specific set of images which has a degree of similarity exceeding the pre-set value and allowing images determined to have degrees of similarity exceeding the pre-set value with the tag information to be automatically written onto the image database.

### CROSS-REFERENCE TO RELATED APPLICATION

This application claims priority to and incorporates herein by reference all disclosure in Korean Patent Application No. 10-2011-0010624 filed Feb. 7, 2011.

### TECHNICAL FIELD

The present invention relates to a method, a system and a computer-readable recording medium for writing a new image and its information onto the image database; and more particularly, to the method, the system and the computer-readable recording medium for adding an unrecognized image and its tag information onto the image database more easily by searching a result of a queried image by referring to the image database; storing/grouping the images which are not recognized in spite of the above-mentioned search process onto a separate database; and verifying the unrecognized images in the use of images automatically acquired through, e.g., web crawling, and their tags (or images manually provided by a user and their tags).

### BACKGROUND OF THE INVENTION

Recently with the development of telecommunication technology and the wide spread use of the Internet, a variety of search methods are adopted. For example, computer users may search for information by using the Internet (more accurately web services) in addition to getting the information directly from a dictionary or others who are familiar with the information. In short, after accessing to a web server that provides a search service by using a browser and entering a keyword relating to the information he/she wants to find, a user may be provided with the search service.

A variety of search services have been developed and particularly in Korea, searches for knowledge have become of greater importance. As such, the search service for getting information is more increasingly used. For the reason that the search service is used by many users and it is common that the visits of users to a website are directly connected to advertising profits, many portals offer the search service.

The websites providing such search service have been increased in quantity but most have offered the same search services centered on texts including keywords, and thus, they fail to fulfill the desire of the users who want to get the information more easily by using more diverse methods.

In particular, according to a conventional art, if the information they wanted to get was not a text but an image, they had to guess a keyword which seemed to be associated with the image and then enter the keyword to perform a search. Of course, only the results corresponding to the image could be shown by setting a search scope but such image search itself was merely one of searches based on texts including keywords.

The problem of the conventional art is that, if a user does not know what the identity of the image is, the user could not easily guess a concerned keyword and get what the user wants.

Accordingly, to solve the problems, an image retrieval system was developed to allow a user, etc. who wants to get information on a specific image to search by using not a text but an image itself.

However, the existing image retrieval system had the following problems:

First, an image database requires plenty of data to provide the image retrieval system.

With the database lacking sufficient data, even if a queried image was inputted, the system could not provide information on search results occasionally and all the queried images which failed to be matched with any image in the image database, i.e., the unrecognized images, came to be abandoned without being recycled. In such a case, until the unrecognized images were reflected manually on the image database, the system could not provide the information on the search results of the unrecognized images even if the searches were repeated.

### SUMMARY OF THE INVENTION

It is an object of the present invention to solve all the problems mentioned above.

It is another object of the present invention to store and group a queried image, which is not recognized in spite of the process of comparing it with images in an image database, in a separate database and verify the unrecognized image by using an image automatically acquired in a method of web crawling, etc. (or images manually provided by a user) and its tag information (i.e., information corresponding to the image) to allow the unrecognized images, i.e., the newly recognized images, and the tag information to be easily written onto the image database.

In accordance with one aspect of the present invention, there is provided a method for writing a new image and its information onto an image database including the steps of: (a) comparing pre-stored image on the image database with a queried image, if inputted, to search whether there are any images similar to the queried image in the image database; (b) storing the queried image onto a database for unrecognized images if there is no image similar to the queried image as a search result; (c) grouping the images in the database for unrecognized images based on degrees of similarity thereamong to organize sets of images; and (d) comparing, if a specific image and its tag information are inputted from outside, the specific image with at least some images included in a specific set of images among the organized sets of the images, determining whether there is any image in the specific set of images which has a degree of similarity exceeding the pre-set threshold value and allowing at least one of the images determined to have degrees of similarity in excess of the pre-set threshold value with the tag information inputted from outside to be automatically written onto the image database.

In accordance with another aspect of the present invention, there is provided a system for writing a new image and its information onto an image database including: a search part for comparing pre-stored image in the image database with a queried image, if inputted, to search whether there are any images similar to the queried image in the image database; an unrecognized image storing part for storing the queried image onto a database for unrecognized images if there is no similar image to the queried image as a search result; an unrecognized image set organizing part for grouping the images in the database for unrecognized images based on degrees of similarity thereamong to organize sets of images; and a new image writing part for comparing, if a specific image and its tag information are inputted from outside, the specific image with at least some images included in a specific set of images among the organized sets of the images, determining whether there is any image in the specific set of images which has a degree of similarity exceeding the pre-set threshold value and allowing at least one of the images determined to have degrees of similarity in excess of the pre-set threshold value with the tag information inputted from outside to be automatically written onto the image database.

### BRIEF DESCRIPTION OF THE DRAWINGS

The above and other objects and features of the present invention will become apparent from the following description of preferred embodiments given in conjunction with the accompanying drawings, in which:

FIG. 1 is a drawing of illustrating a configuration of a whole system briefly for writing a new image and its information onto an image database in accordance with an example embodiment of the present invention.

FIG. 2 is a diagram exemplarily representing a configuration of an image processing system 200 in accordance with an example embodiment of the present invention.

FIG. 3 illustrates examples of grouping images stored on a database for unrecognized images on the basis of degrees of similarity thereamong in accordance with an example embodiment of the present invention.

FIGS. 4A and 4B explain an example embodiment of organizing a set of images by grouping images stored on the database for unrecognized images on the basis of degrees of similarity thereamong in accordance with an example embodiment of the present invention.

FIGS. 5A to 5D are drawings exemplarily showing the configuration of normalizing feature regions in accordance with an example embodiment of the present invention.

FIGS. 6A and 6B are diagrams exemplarily showing the distribution of feature regions respectively included in an image collected by a web crawler and an image included in a set of images.

### DETAILED DESCRIPTION OF THE PREFERRED EMBODIMENTS

The detailed description of the present invention illustrates specific embodiments in which the present invention can be performed with reference to the attached drawings.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The configurations of the present invention for accomplishing the objects of the present invention are as follows:

### Configuration of Whole System

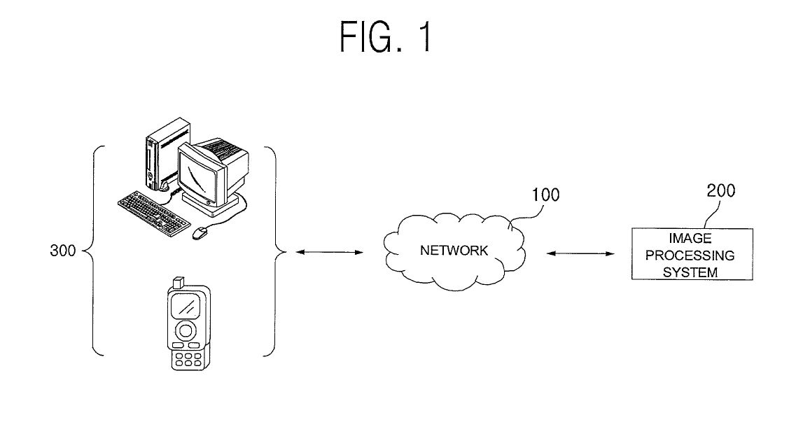

FIG. 1 is a drawing of illustrating a configuration of a whole system briefly for writing a new image and its information onto an image database in accordance with an example embodiment of the present invention.

As illustrated in FIG. 1, the whole system in accordance with an example embodiment of the present invention may include a network 100; an image processing system 200 capable of writing a new image and its information onto an image database; and a user terminal 300.

First of all, the network 100 may be configured, regardless of wired or wireless, in a variety of networks, including a local area network (LAN), a metropolitan area network (MAN), a wide area network (WAN), etc. More preferably, the network 100 in the present invention may be the World Wide Web (www).

In accordance with an example embodiment of the present invention, if a queried image is inputted from the user terminal 300 to the image processing system 200 through the network 100, the image processing system 200 compares the pre-stored images on an image database with the queried image (i.e., searches whether there is any image similar to the queried image on the image database or not) and, if there is no similar image as the search result, performs a function of storing the queried image on a database for unrecognized images. At the time, it may browse whether there is an image similar to the queried image on the image database by comparing normalized feature regions of the pre-stored images on the image database with those of the queried image.

Furthermore, the image processing system 200 in accordance with an example embodiment of the present invention may collect images, which are associated thereamong, stored on the database for unrecognized images by using degrees of similarity to thereby create one or more sets of images. At the time, if a specific image and its tag information is acquired from outside (e.g., a web crawler or a user terminal), the image processing system 200 may compare the specific image with images in a specific set of images among the above-mentioned sets of images and determine whether at least some of the images in the specific set of images have degrees of similarity exceeding the pre-set threshold value and, if the image is determined to have the degree of similarity exceeding the pre-set threshold value, the image processing system 200 may allow at least some of images in the specific set of images and the tag information acquired from outside as mentioned above to be automatically written on the image database to be explained below.

Specifically, if data (data in the specific set of images or all data stored on the database for unrecognized images) are collected exceeding the predetermined number of data, the image processing system 200 in accordance with an example embodiment of the present invention may determine whether at least some of images in the specific set of images are associated with the crawled data and/or data inputted by a user and, if at least part of the images are determined to have connections, the image processing system 200 may write onto the image database at least some of images and appropriate tag information which is included in the crawled data and/or inputted by the user. The detailed explanation on the internal configuration of the image processing system 200 will be explained below.

Moreover, the user terminal 300 in accordance with an example embodiment of the present invention is a digital device which includes a function to enable the user to access to the image processing system 200 and then communicate with the system 200 and digital devices, including a personal computer (e.g., desktop, laptop, etc.), a workstation, a PDA, a web pad, a cellular phone, which have memory means and microprocessors with a calculation ability, may be adopted as the user terminal 300 in accordance with the present invention.

### Configuration of Image Processing System

Below is an explanation on an internal configuration of the image processing system 200 which performs an important function for the implementation of the present invention and a function of each component of the system 200.

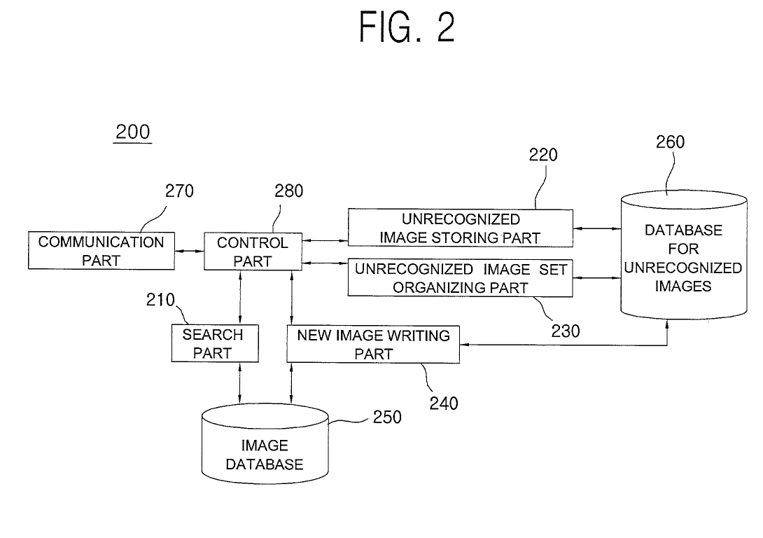

FIG. 2 is a diagram exemplarily representing the internal configuration of the image processing system 200 in accordance with an example embodiment of the present invention.

By reference to FIG. 2, the image processing system 200 in accordance with an example embodiment of the present invention may include a search part 210, an unrecognized image storing part 220, an unrecognized image set organizing part 230, a new image writing part 240, an image database 250, a database for unrecognized images 260, a communication part 270 and a control part 280.

In accordance with an example embodiment of the present invention, the search part 210, the unrecognized image storing part 220, the unrecognized image set organizing part 230, the new image writing part 240, the image database 250, the database for unrecognized images 260, the communication part 270 and the control part 280 may be program modules whose at least some may communicate with the user terminal 300. Such program modules may be included in a form of an operating system, an application program module and other program modules, or they may be stored either in various storage devices well known to those skilled in the art or in a remote storage device capable of communicating with the terminal or the server. The program modules may include but not be subject to a routine, a subroutine, a program, an object, a component, and a data structure for executing a specific operation or a type of specific abstract data that will be described in accordance with the present invention.

First, if a queried image is inputted to the search part 210, the search part 210 in accordance with an example embodiment of the present invention may compare the queried image with already stored images on the image database 250 and finding out whether there are any images similar to the queried image on the image database 250 or not.

Specifically, the search part 210 in accordance with an example embodiment of the present invention may perform a function of comparing a normalized feature region(s) of the already stored images on the image database 250 with that (those) of the queried image and searching whether there are any images similar to the queried image on the image database 250 or not.

Herein, the search part 210, the unrecognized image set organizing part 230 and the new image writing part 240 may be allowed to pre-extract a feature(s) and a feature region(s) from the plurality of images for the matching process, i.e., comparing process. The feature herein means a point including a feature element of an object included in the image and the feature region herein means an area around the feature which includes characteristics of the object. The feature region may be set to be robust to changes in a viewpoint and an illumination of the image.

As mentioned above, to extract a feature and a feature region from the image, a feature extraction technology is required. In accordance with an example embodiment of the present invention, an article titled “A combined corner and edge detector” authored jointly by C. Harris and one other and published in “In Alvey Vision Conference” in 1988 and the like may be referred to as such feature recognition technology (The whole content of the article may be considered to have been combined herein). The article describes a method for guessing elliptic feature regions by using a second moment matrix which represents slop distributions around the feature. Of course, the feature extraction technology applicable to the present invention is not limited only to the method mentioned in the article and it will be able to reproduce the present invention by applying various examples.

Second, if there is no image similar to the queried image on the image database 250 as a search result by the search part 210, the unrecognized image storing part 220 in accordance with an example embodiment of the present invention may perform a function of storing the queried image on the database for unrecognized images 260.

In addition, the unrecognized image set organizing part 230 in accordance with an example embodiment of the present invention performs a function of grouping images with high relevance by referring to degrees of similarity of the images thereamong stored on the database for unrecognized images 260 (e.g., the degrees of similarity higher than the pre-fixed value) and organizing a set(s) of the images. More particularly, the unrecognized image set organizing part 230 performs a function of comparing features or feature regions of the images stored on the database for unrecognized images 260, grouping the images considered to have high degrees of similarity thereamong and organizing a set(s) of the images.

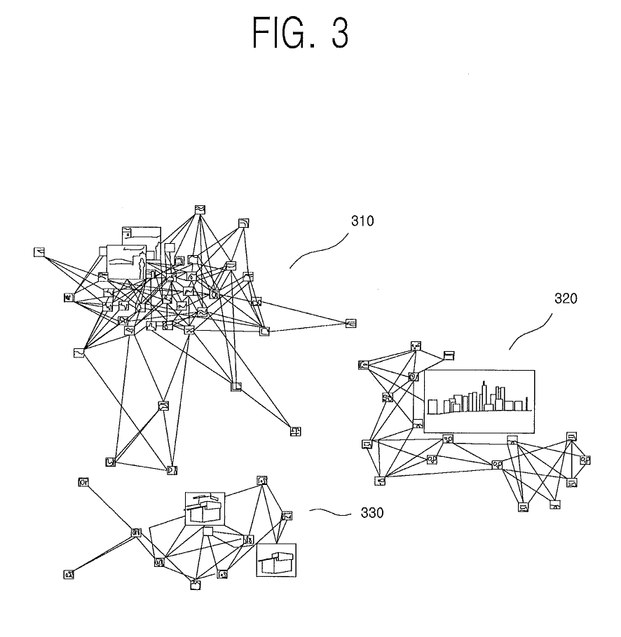

FIG. 3 illustrates that the unrecognized image set organizing part 230 in accordance with an example embodiment of the present invention groups the images with high degrees of similarities thereamong stored on the database for unrecognized images 260 and organizes a set(s) of the images. By referring to FIG. 3, the unrecognized image set organizing part 230 may group the images stored (by the unrecognized image storing part 220) on the database for unrecognized images 260 by using degrees of similarity thereamong and organizing sets of the images like 310, 320, and 330.

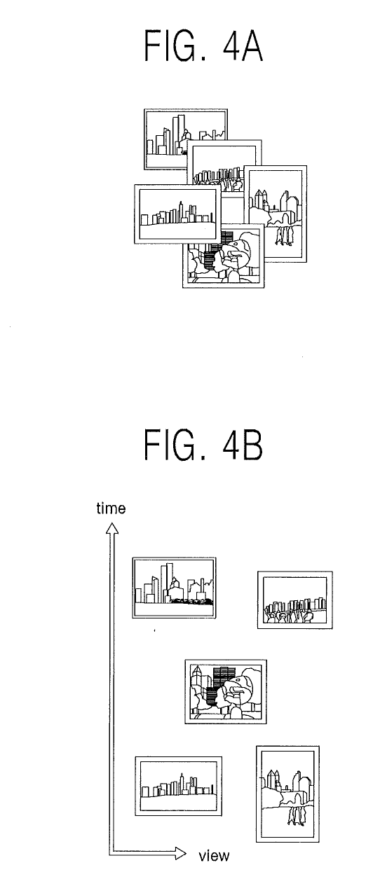

Besides, FIGS. 4A and 4B illustrate an example embodiment of the unrecognized image set organizing part 230 in accordance with an example embodiment of the present invention grouping images with high degrees of similarity thereamong stored on the database for unrecognized images 260 and organizing a set of the images. By referring to FIGS. 4A and 4B, the unrecognized image set organizing part 230 in accordance with an example embodiment of the present invention first may group images stored on the database for unrecognized images with high degrees of similarities thereamong by applying a matching scheme to the images stored on the database for unrecognized images as shown in FIG. 4A. Next, in order to organize the grouped images as sets of structured images as shown in FIG. 4A, the unrecognized image set organizing part 230 in accordance with an example embodiment of the present invention may array, structure and store the grouped images by time and by a variety of viewpoints. FIG. 4B illustrates an example embodiment of the unrecognized image set organizing part 230 capable of arraying and structuring the grouped images by time and by a variety of viewpoints but it is not necessary to be limited to this case. That is, the unrecognized image set organizing part 230 in accordance with an example embodiment of the present invention may be possible to organize sets of images in a diversity of methods.

In accordance with an example embodiment of the present invention, if a specific image and its tag information is acquired from a web crawler (not illustrated), from a user terminal 300 or the like, the new image writing part 240 may compare the specific image with at least some images included in a specific set of images and determine whether degrees of similarity therebetween exceed the pre-set threshold value or not and, if the degrees of similarity are in excess of the pre-set threshold value, the new image writing part 240 may perform a function of allowing at least some images and the acquired tag information to be automatically written onto the image database 250. At the time, if the number of data included in the specific set of images is collected by unrecognized image set organizing part 230 or the number of data included on the database for unrecognized images 260 fully exceeds the predetermined number, the new image writing part 240 in accordance with an example embodiment of the present invention may allow the analysis (i.e., the image matching process) to be performed.

Besides, since the images collected by a web crawler, etc. and the images included in the set(s) of images, which are subject to matching, may be images photographed from different viewpoints in different luminance environments, even feature region included in each of the images may be differently extracted in size and shape depending on the viewpoints and the luminances. Therefore, it might be difficult to match the images accurately only by directly comparing the feature regions of the images collected by the web crawler, etc. and those of the images included in the set(s) of images. The images collected by the web crawler hereby are assumed for convenience but the images collected by the user terminal 300 may be necessarily included.

To solve the problem caused by the extractions of feature regions whose size and shape are dependent on the viewpoints and the luminances, the new image writing part 240 in accordance with an example embodiment of the present invention may normalize the size and the shape of each of the feature regions included, respectively, in the images collected by the web crawler, etc. and in the images in the set(s) of images and then perform the image matching based on each of the normalized feature regions to thereby compensate errors caused by various viewpoints and luminances.

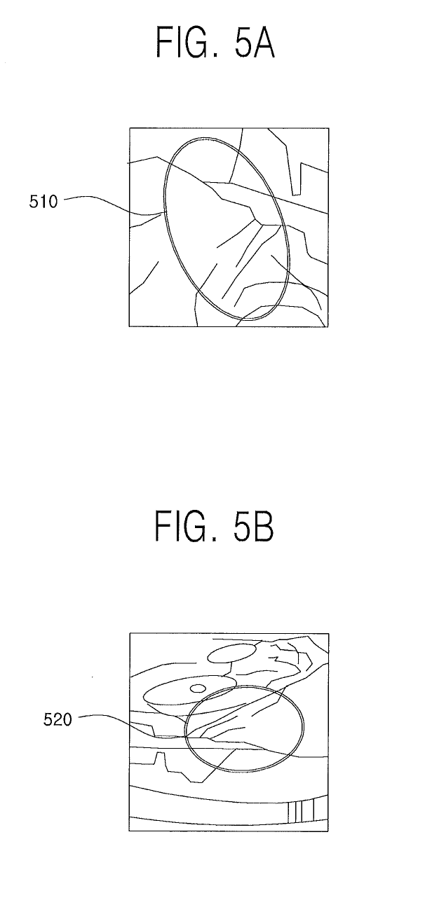

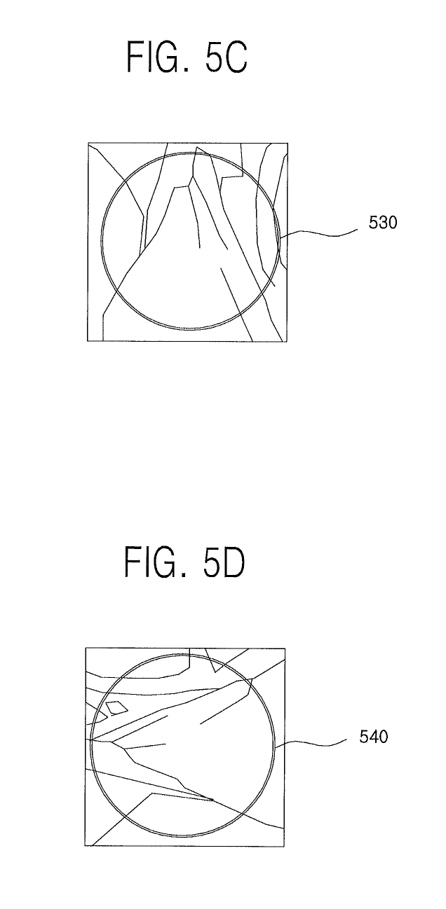

FIGS. 5A to 5D are diagrams of exemplarily showing the configuration of normalizing feature regions in accordance with an example embodiment of the present invention. FIG. 5A shows a feature region 510 extracted from the image collected by the web crawler, etc. and FIG. 5B shows a feature region 520 extracted from the images included in the set of images. By referring to FIGS. 5A and 5B, it may be found that, although each image shows a same object, the same feature region of the same object is displayed differently in size and shape due to different viewpoints or luminances and that a feature region 510 and a feature region 520 with different sizes and shapes are extracted from the image of FIG. 5A and the image of FIG. 5B respectively.

In accordance with an example embodiment of the present invention, the new image writing part 240 may normalize a pair of feature regions with different sizes and shapes as a pair of feature regions with same size and shape by using a normalization technology. That is, the new image writing part 240 may normalize a pair of feature regions 510 and 520 as shown in FIGS. 5A and 5B respectively to thereby generate a pair of feature regions 530 and 540 as shown in FIGS. 5C and 5D.

As stated above, to normalize each feature region extracted from the images, a technology of normalizing a feature region is required. As such technology of normalizing a feature region, in accordance with an example embodiment of the present invention, an article titled “A Comparison of Affine Region Detectors” authored by K. MIKOLAJCZYK and other seven and published on “International Journal of Computer Vision” in November 2005 and the like may be referred to (The whole content of the article must be considered to have been combined herein). The article describes a method for normalizing elliptic feature regions in various sizes and shapes as circles in a specific size and a specific shape by using second moment matrixes M_{L}^{1/2} and M_{R}^{1/2}, which guess the viewpoints and the luminance conditions of the images, and a method for rotating the normalized feature region by using a rotation matrix R to determine whether a pair of normalized feature regions point out a same object or not. Of course, the normalization technology applicable to the present invention is not limited to the method described in the above-mentioned article and it will be able to reproduce the present invention by applying various examples.

Moreover, the new image writing part 240 in accordance with an example embodiment of the present invention may compare at least one normalized feature region of an image in the set of images with at least one normalized feature region of the collected image and retrieve at least one pair of feature regions from each of the images which are considered to indicate the same object. In addition, if at least two pairs of feature regions are retrieved, the new image writing part 240 in accordance with an example embodiment of the present invention may compare relative location relationships between at least two feature regions of the image in the set of images, which correspond to the above-mentioned at least two pairs of feature regions, with those between at least two feature regions of the collected image, which correspond to the above-mentioned at least two pairs of feature regions, by using topology and determine whether at least two pairs of feature regions therebetween are matched with each other or not.

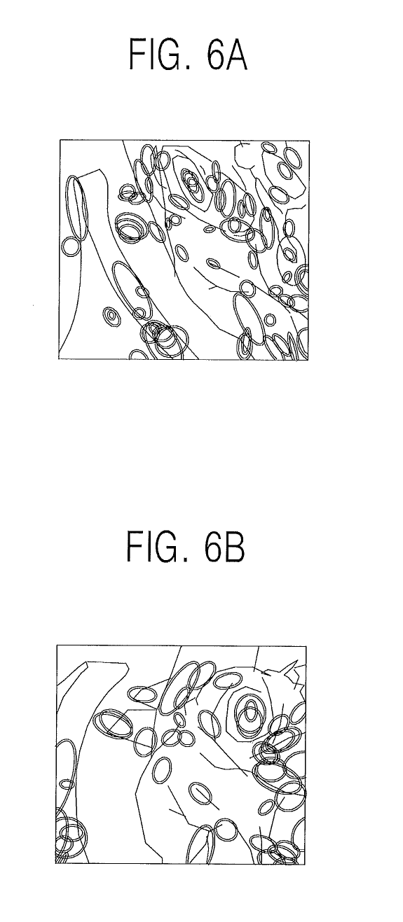

FIGS. 6A and 6B are diagrams exemplarily showing the distribution of feature regions included in an image collected by a web crawler and an image included in a set of images. By referring to FIGS. 6A and 6B, the new image writing part 240 in accordance with an example embodiment of the present invention may determine a degree of similarity between the image collected by the web crawler, etc. (i.e., the image of FIG. 6A) and the image in the set of images (i.e., the image of FIG. 6B) by comparing the relative location relationships between multiple feature regions of the former image and those of the latter image.

As mentioned above, to determine the degree of similarity between two different images by using relative location relationships of the feature regions, a technology of topology is required. In accordance with an example embodiment of the present invention, as such technology of topology, an article “Image matching using algebraic topology” authored by DERDAR Salah and two others and published on “Proceedings of SPIE, Vol. 6066” in January 2006 and so on may be referred to (The whole content of the article must be considered to have been combined herein). The aforementioned article describes a method for measuring a degree of similarity between two images by referring to boundary elements of features included in each of the images through algebraic topology technology. Of course, the topology technology applicable to the present invention is not limited to the method described in the above-mentioned article and it will be able to reproduce the present invention by applying various examples.

As explained above, the image matching method in accordance with the present invention may achieve an effect of improving accuracy of matching between the image collected by the web crawler, etc. and the image included in the set of images.

When the new image writing part 240 has to write a newly recognized image and its acquired information onto the image database 250, the new image writing part 240 may write n-pieces of representative images which stand for the newly recognized image and a representative tag(s) corresponding to the representative images. Furthermore, the new image writing part 240 in accordance with an example embodiment of the present invention may additionally write m-pieces of sub images which reflect on different viewpoints, luminances or time while it is writing the representative images onto the image database 250. In addition, it may be possible to selectively add sub tags relating to the sub images, where the representative image(s) and the sub image(s) share one or more features or feature regions.

Moreover, in accordance with an example embodiment of the present invention, the image database 250 is a database which includes the images whose identities are completely recognized and their tags and the database for unrecognized images 260 is a database which stores images or queried images failing to be matched as a result of retrieval by the search part 210.

Besides, the image database 250 and the database for unrecognized images 260 are databases not only in a narrow meaning but also in a broad meaning which include data records, etc. based on computer file systems. From the aspect, it must be understood that, even a set of simple operation processing logs may be included in the database(s) in the present invention if it can be browsed and data can be extracted from the set. The image database 250 and the database for unrecognized images 260 are illustrated in FIG. 2 as if they are included in the image processing system 200, but they will be possibly configured separately from the image processing system 200 at the necessity of a person skilled in the art who implements the present invention.

The Communication part 270 in accordance with an example embodiment of the present invention may perform a function of enabling the image processing system 200 communicating with an external device such as the user terminal 300.

In accordance with an example embodiment of the present invention, the control part 280 may perform a function of controlling data flow among the search part 210, the unrecognized image storing part 220, the unrecognized image set organizing part 230, the new image writing part 240, the image database 250, the database for unrecognized images 260 and the communication part 270. In other words, the control part 280 may control the flow of data from outside or among the components of the image processing system 200 to thereby force the search part 210, the unrecognized image storing part 220, the unrecognized image set organizing part 230, the new image writing part 240, the image database 250, the database for unrecognized images 260 and the communication part 270 to perform their unique functions.

In accordance with an example embodiment of the present invention, the whole image processing system 200 or at least part of its components, including the search part 210, the unrecognized image storing part 220, the unrecognized image set organizing part 230, the new image writing part 240, the image database 250, the database for unrecognized images 260, the communication part 270 and the control part 280, may be implemented by a cloud computing server that virtualizes multiple server devices sharing computing resources or server resources.

In accordance with the present invention, even if the image database does not have sufficient data, it will be possible to reasonably use queried images, which fail to be matched with the images stored on the image database, and therefore, an effect of implementing the automatically evolving image database may be finally achieved.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

While the invention has been shown and described with respect to the preferred embodiments, it will be understood by those skilled in the art that various changes and modification may be made without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

What is claimed is:

1. A method for writing a new image and its information onto an image database comprising the steps of:
(a) comparing pre-stored image in the image database with a queried image, if inputted, to search whether there are any images similar to the queried image in the image database;
(b) storing the queried image onto a database for unrecognized images if there is no image similar to the queried image as a search result;
(c) grouping the images in the database for unrecognized images based on degrees of similarity thereamong to organize sets of images; and
(d) comparing, if a specific image and its tag information are inputted from outside, the specific image with at least some images included in a specific set of images among the organized sets of the images, determining whether there is any image in the specific set of images which has a degree of similarity exceeding the pre-set threshold value and allowing at least one of the images determined to have degrees of similarity in excess of the pre-set threshold value with the tag information inputted from outside to be automatically written onto the image database.

2. The method of claim 1 wherein, at the step (d), the specific image and its tag information are received from a web crawler or a user terminal.

3. The method of claim 1 wherein, at the step (a), if the queried image is inputted, whether there is any image similar to the queried image or not is searched by comparing a normalized feature region of the pre-stored image in the image database with that of the queried image.

4. The method of claim 1 wherein, at the step (c), the degrees of similarity are determined by comparing features or feature regions of the images in the database for unrecognized images to thereby organize the set of images.

5. The method of claim 1 wherein, at the step (c), if the number of data included in the specific set of images or the number of data stored in the database for unrecognized images, exceeding the predetermined number, is collected, the step (d) is performed.

6. The method of claim 1 wherein, at the step (d), normalized feature regions of an image in the specific set of images are compared with those of the specific image; at least one pair of feature regions which are considered to indicate a same object are retrieved from each of the images; and the degree of similarity between the specific image and the image in the specific set of images is determined.

7. The method of claim 6 wherein, at the step (d), if at least two pairs of feature regions are retrieved from each of the images, relative location relationships between at least two feature regions of the image in the specific set of images and those between at least two feature regions of the specific image are compared by using a topology technology to determine whether the image in the specific set of images and the specific image are matched or not.

8. The method of claim 1 wherein, at the step (d), n-pieces of representative images, which stand for at least some images in the specific set of images, and their representative tag(s) is written onto the image database.

9. The method of claim 8 wherein m-pieces of sub images reflecting different viewpoints, different luminances or different time from the representative images are written together.

10. The method of claim 9 wherein, when the sub images are additionally written, their sub tag(s) is written with the sub images.

11. The method of claim 9 wherein the representative images and the sub images share at least one feature or feature region.

12. The method of claim 1 wherein at least one of the steps (a), (b), (c), and (d) is executed by a cloud computing server, which virtualizes multiple server devices sharing computer resources or server resources.

13. A system for writing a new image and its information onto an image database comprising:
a search part for comparing pre-stored image in the image database with a queried image, if inputted, to search whether there are any images similar to the queried image in the image database;
an unrecognized image storing part for storing the queried image onto a database for unrecognized images if there is no similar image to the queried image as a search result;
an unrecognized image set organizing part for grouping the images in the database for unrecognized images based on degrees of similarity thereamong to organize sets of images; and
a new image writing part for comparing, if a specific image and its tag information are inputted from outside, the specific image with at least some images included in a specific set of images among the organized sets of the images, determining whether there is any image in the specific set of images which has a degree of similarity exceeding the pre-set threshold value and allowing at least one of the images determined to have degrees of similarity in excess of the pre-set threshold value with the tag information inputted from outside to be automatically written onto the image database.

14. The system of claim 13 wherein the outside includes a crawler or a user terminal.

15. The system of claim 13 wherein, if the queried image is inputted, the search part searches whether there is any image similar to the queried image or not by comparing a normalized feature region of the pre-stored image in the image database with that of the queried image.

16. The system of claim 13 wherein the unrecognized image storing part determines the degrees of similarity by comparing features or feature regions of the images in the database for unrecognized images to thereby organize the set of images.

17. The system of claim 13 wherein, if the number of data of the specific set of images collected by the unrecognized image set organizing part or the number of data stored in the database for unrecognized images is in excess of the predetermined number, the new image writing part automatically writes at least some images with the inputted tag information on the image database.

18. The system of claim 13 wherein the new image writing part compares normalized feature regions of an image in the specific set of images with those of the specific image; retrieves at least one pair of feature regions which are considered to indicate a same object from each of the images; and determines the degree of similarity between the specific image and the image in the specific set of images.

19. The system of claim 18 wherein, if at least two pairs of feature regions are retrieved from each of the images, the new image writing part compares relative location relationships between at least two feature regions of the image in the specific set of images and those between at least two feature regions of the specific image by using a topology technology to determine whether the image in the specific set of images and the specific image are matched or not.

20. The system of claim 13 wherein the new image writing part writes n-pieces of representative images, which stand for at least some images in the specific set of images, and their representative tag(s) onto the image database.

21. The system of claim 20 wherein m-pieces of sub images reflecting different viewpoints, different luminances or different time from the representative images are written together.

22. The system of claim 21 wherein, when the sub images are additionally written, their sub tag(s) is additionally written with the sub images.

23. The system of claim 21 wherein the representative images and the sub images share at least one feature or feature region.

24. The system of claim 13 wherein the system is run by a cloud computing server that virtualizes multiple server devices sharing computing resources or server resources.

25. One or more computer-readable recording media having stored thereon a computer program that, when executed by one or more processors, causes the one or more processors to perform acts including:
comparing pre-stored image in the image database with a queried image, if inputted, to search whether there are any images similar to the queried image in the image database;
storing the queried image onto a database for unrecognized images if there is no image similar to the queried image as a search result;
grouping the images in the database for unrecognized images based on degrees of similarity thereamong to organize sets of images; and
comparing, if a specific image and its tag information are inputted from outside, the specific image with at least some images included in a specific set of images among the organized sets of the images, determining whether there is any image in the specific set of images which has a degree of similarity exceeding the pre-set threshold value and allowing at least one of the images determined to have degrees of similarity in excess of the pre-set threshold value with the tag information inputted from outside to be automatically written onto the image database.
